(19) United States
(12) Patent Application Publication
(10) Pub. No.: US 2008/0147522 A1
(43) Pub. Date: Jun. 19, 2008

(54) Method and system for generating check confirmation data from check printing data file

(75) Inventor: Thomas J. Foth, Trumbull, CT (US)

Correspondence Address: PITNEY BOWES INC.;35 WATERVIEW DRIVE, P.O. BOX 3000, MSC 26-22, SHELTON, CT, 06484-8000, US

(73) Assignee: Pitney Bowes Incorporated, Stamford, CT (US)

(21) Appl. No.: 11/638,049

(22) Filed: Dec. 13, 2006

(51) Int. Cl. G06Q 40/00; G06F 3/12

(52) U.S. Cl. 705/30; 705/35; 358/1.15

(57) ABSTRACT

An intermediary program obtains check printing data generated by an application program. The intermediary program collects check attribute data from the check printing data and then can pass the check printing data on to the print driver. The intermediary program transmits the check attribute data as a “positive pay” data to the bank which is the drawee of the checks.

### BACKGROUND

This invention is concerned with methods for preventing check fraud, and is more particularly concerned with methods in which an issuer of checks provides data concerning the checks to a drawee bank.

Check fraud is a significant problem for banks and issuers of checks; systematic efforts to combat check fraud are well known. So-called “positive pay” systems are one accepted anti-fraud technique. In positive pay systems, an issuer of checks sends data to the drawee bank to inform the drawee bank in advance about the attributes of checks from the issuer that the drawee bank should expect to have presented to it for payment. If the drawee bank receives a check drawn on the issuer's account which does not match the previously received “positive pay” data, then the bank is alerted to undertake inquiries before paying the check.

FIG. 1 is a flow diagram that illustrates a conventional positive pay system. At 102 in FIG. 1, an issuer of checks uses an application software package such as an accounting package to generate check printing data print one or more checks. The application software package also has the capability of generating the positive pay data to be sent to the drawee bank, and generates the positive pay data in the same or a related operation in conjunction with printing the one or more checks.

According to conventional practices, the positive pay data file includes, for each check, data which conveys attributes of the check such as, for example, the date of the check, the serial number of the check, the number of the account upon which the check is drawn, the dollar amount for which the check is drawn, and the name of the payee. In some cases a subset or a superset of this data, or another combination of check attributes, is included in the positive pay data file.

At 104 in FIG. 1, the application software package passes the data required for check printing to a conventional print driver. At 106, the print driver causes a printer (not shown) to print the one or more checks, which are mailed to the payee(s).

At 108 in FIG. 1, the application software package and/or communication software operating in the same computer causes the positive pay data file to be transmitted to the drawee bank's computer. The electronic transmission of this data (and/or the data channel by which such transmission occurs) is indicated at 110.

In due course, the payees (not shown) present the checks for deposit and/or collection to their banks, which use the check clearing system (indicated at 112) to present the checks for payment by the drawee bank. At 114 in FIG. 1, the drawee bank scans the checks to extract from the checks the attributes of the checks such as those listed above. In the meantime (and presumably well before the checks are presented for payment to the drawee bank), the bank has received (as indicated at 116 the positive pay data. At 118 the drawee bank determines with respect to each check whether it has received positive pay data (i.e., the check attribute data sent via the channel 110) that matches the check attribute data extracted from the check at 114. If so, the check is paid (step 120). If the bank has not received matching positive pay data for the check (e.g., if the positive pay data received for the check does not match the data obtained by scanning the check), then the bank may defer payment of the check until suitable inquiries are made, as per step 122.

One difficulty with the positive pay system as implemented in the manner described above is that banks tend to have varying requirements as to the check attribute data to be submitted by the check issuers. In addition, there are variations in the format in which the check attribute data is to be submitted. As a result, it may be expensive, or even impractical, to provide and/or modify the accounting application software such that it can assemble the “positive pay” file in a manner that is acceptable to the drawee bank.

In another proposed manner of operating a positive pay system, the accounting application does not assemble the positive pay file. Instead, after the check printing operation a stand-alone application software package assembles a positive pay file by accessing a database of check data maintained by the check issuer's computer. However, in addition to the need to meet the drawee bank's requirements for check attribute content and format, the application which assembles the positive pay file also must operate in a manner that reflects the database schema employed for the check data. Again, this may tend to produce a greater variety of requirements than the application can readily cope with.

### SUMMARY

According to an aspect of the invention, a method includes using an intermediary program to parse print data being sent from an application program, which may be, for example, an accounting program, to a print driver. The print data is suitable for causing the print driver program to print one or more checks utilizing a printer. The parsing of the print data identifies data fields in the print data. The data fields are indicative of attributes of the checks. The method also includes storing data from the identified data fields. The stored data is check attribute data. In addition, the method can include printing the checks. Still further, the method includes transmitting the stored check attribute data to a bank upon which the checks are drawn.

The parsing of the print data may include detecting, for at least some blocks of text within the print data, what check attributes the blocks of text correspond to. The detecting of what check attributes the blocks of text correspond to may include reading contents of the blocks of text and/or determining at what position in the check one of the blocks of text is to be printed.

The stored check attribute data may include any combination of one or more of (a) the date of the checks, (b) dollar amounts of the checks, (c) serial numbers of the checks, (d) names of payees of the checks, (e) the account number which corresponds to the account on which the checks are drawn, (f) a check routing number, and (g) the signature on the checks.

The check attribute data may be stored in the form of an XML (Extensible Markup Language) file. The transmitting of the check attribute data to the bank may include translating the XML file with an XSLT (Extensible Stylesheet Language Transformations) transformation to produce the output file. The output file may be in a format prescribed by the bank and may be transmitted to the bank.

The method may further include allowing a user to select a printer from among a plurality of printers, receiving an indication from the user as to selection of the printer, and selecting the print driver program from among a plurality of print driver programs. The selecting of the print driver program may be based at least in part on the indication from the user as to selection of the printer.

In another aspect of the invention, an apparatus is provided which includes a processor and a memory in communication with the processor. The processor stores program instructions. The processor is operative with the program instructions to perform the method steps described in the preceding paragraphs.

In still another aspect of the invention, a method of protecting against check fraud is provided. The method includes using an accounting application program to generate check printing data for one or more checks. Each check includes a plurality of text blocks. The method further includes invoking a print function of the accounting application program with respect to the check printing data. The method also includes parsing of the check printing data by an intermediary program. The parsing includes reading at least some of the text blocks to detect a type of data included in each of the text blocks. The detecting of the type of data includes determining with respect to at least some of the text blocks where in the check the text blocks are to be printed. The method also includes extracting data from the text blocks and storing the extracted text data as check attribute data which corresponds to the detected types of data. Still further, the method can include driving a printer to print checks corresponding to the check printing data. In addition, the method includes translating the check attribute data to a format prescribed by the bank on which the checks are drawn, and transmitting the translated check attribute data to the bank.

The method may further include scanning the checks at the bank on which the checks are drawn to extract check attribute data from the scanned checks, and comparing the check attribute data extracted from the scanned checks with the check attribute data transmitted to the bank.

Therefore, it should now be apparent that the invention substantially achieves all the above aspects and advantages. Additional aspects and advantages of the invention will be set forth in the description that follows, and in part will be obvious from the description, or may be learned by practice of the invention. Various features and embodiments are further described in the following figures, description and claims.

### DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like or corresponding parts.

FIG. 1 is a flow diagram that illustrates a conventional manner of implementing a positive pay system.

FIG. 2 is a flow chart that illustrates in overview a manner of implementing a portion of a positive pay system in accordance with aspects of the present invention.

FIG. 3 is a block diagram that illustrates a computer which operates in accordance with aspects of an embodiment of the invention.

FIG. 4 is a schematic representation of software provided in accordance with aspects of the invention to run on the computer of FIG. 3.

FIG. 5 is a block diagram that illustrates a computer system that operates in accordance with aspects of an embodiment of the invention.

FIGS. 6 and 7 are flow charts that illustrate processes performed in the computer of FIG. 3 in accordance with aspects of the invention.

### DETAILED DESCRIPTION

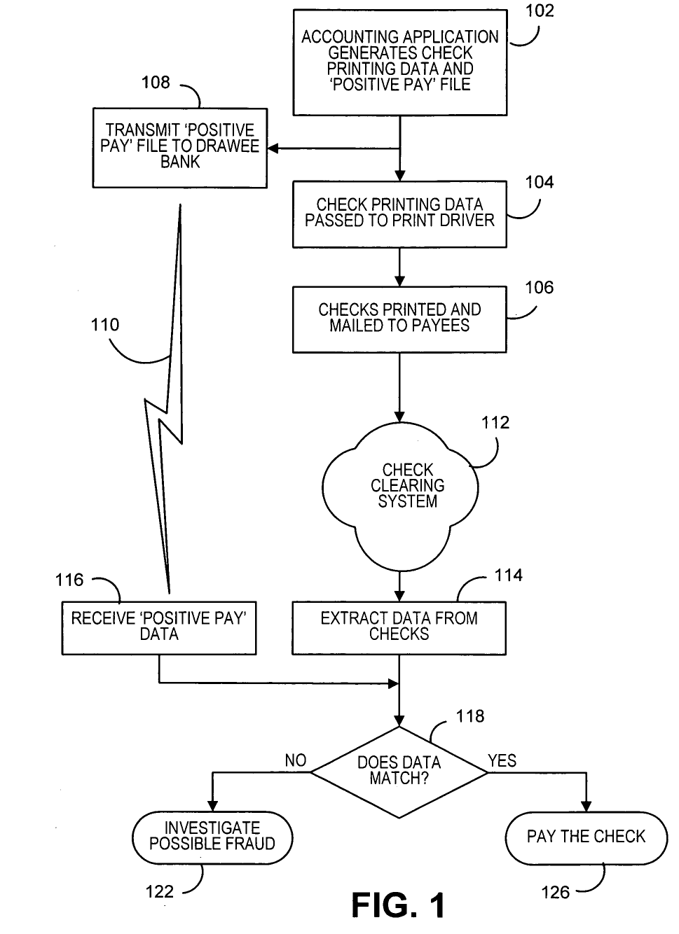

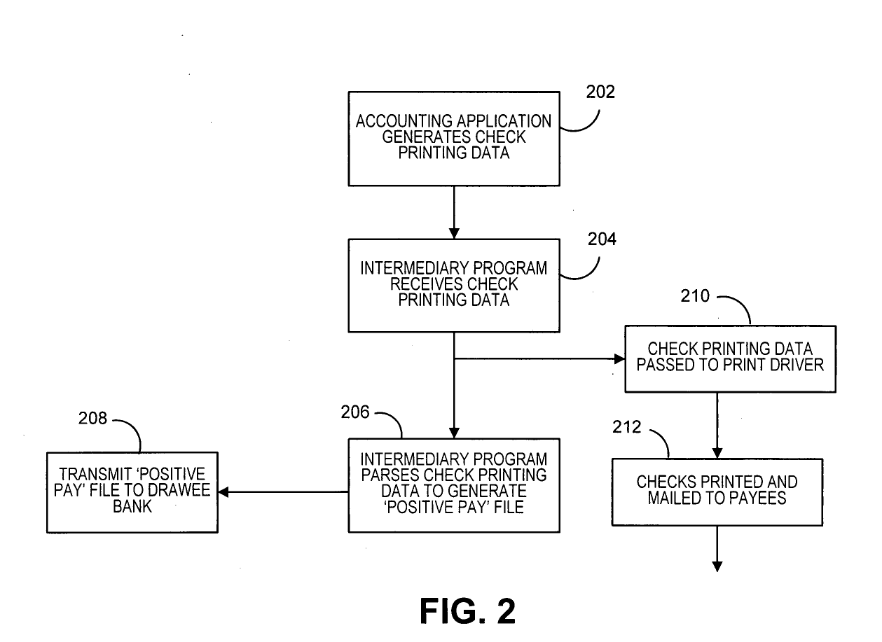

The present invention, in certain of its aspects, provides an improved technique for generating a file of check attribute data to be transmitted to a drawee bank by a check issuer as part of a positive pay system. FIG. 2 is a flow chart that provides an overview of the computer operations performed by the check issuer according to the invention. The functions represented by the blocks shown in FIG. 2 replace the functions shown in blocks 102-108 in FIG. 1. The other functions shown in FIG. 1 (e.g., the bank-side operations) may also be performed in the inventive positive pay system, and in a conventional manner, but are not represented in FIG. 2 in order to simplify the drawing.

At 202 in FIG. 2, an application software package, such as an accounting package, prepares check printing data in a form that is suitable for being passed to a print driver. At 204 in FIG. 2, an intermediary program, provided in accordance with aspects of the invention, receives the check printing data. This can be performed, for example, by the application software package passing the check printing data to the intermediary program. The passing of the check printing data to the intermediary program may occur as a result of invocation of a print function of the application software package, such as by user input which selects a print function. From the point of view of the application software package, the passing of the check printing data may be done in the same manner as if the intermediary program were a print driver. In other words, from the point of view of the application software package, it is simply calling a print driver to print the checks. The application software package may operate entirely in a conventional manner. Alternatively, the check printing data need not be passed directly to the intermediary program, but instead can be passed directly to the print driver (or printer) and simply monitored and read by the intermediary program. For purposes of this specification, the intermediary program receiving the check printing data includes both the intermediary program having the data passed to it from the application program and the intermediary program monitoring and reading the check printing data as it is passed from the application program to the printer for printing. Such monitoring and reading can occur at any point between the application program and the printer.

Regardless of whether the intermediary program receives the check printing data by having it passed directly to it from the application software package or by monitoring and reading the check printing data, at 206 in FIG. 2, the intermediary program parses the check printing data to generate check attribute data which is or may be translated into a file of positive pay data to be sent to the drawee bank. The manner in which the intermediary program parses the check printing data is described in further detail below. Block 208 represents the step of transmitting the positive pay file to the drawee bank.

At 210 in FIG. 2, if the check printing data was sent to the intermediary program, the intermediary program passes the check printing data to a print driver. From the point of view of the print driver, it is as if the check printing data had been passed to it directly from the application software package. The print driver may operate entirely in a conventional manner. Block 212 represents printing of the checks by operation of the print driver, as well as mailing of the checks to the payees. It should be understood, of course, that if the check printing data was not sent to the intermediary program but was only being monitored by the intermediary program, then step 210 is not required as the check printing data is being passed directly to the print driver without going through the intermediary program.

To summarize an aspect of the present invention, an intermediary program receives check printing data by being inserted between a conventional application package, e.g., accounting, and a conventional print driver to serve as a conduit for the check printing data between the accounting application and the print driver, or by monitoring and reading the check printing data being sent from the conventional application package to the conventional print driver. In addition to relaying the check printing data to the print driver (if sent to the intermediary program), the intermediary program derives positive pay data from the check printing data. With such an intermediary program, there is no requirement for the accounting application to be adapted to the needs of the positive pay system, nor is it required to collect the positive pay data after the fact from a check database. Any program customization that may be required is limited to the intermediary program or, preferably, to a utility program which is discussed below. The utility program may operate in association with the intermediary program and may perform any format translation, etc., needed to place the check attribute data gathered by the intermediary program into a suitable condition for transmission to the drawee bank.

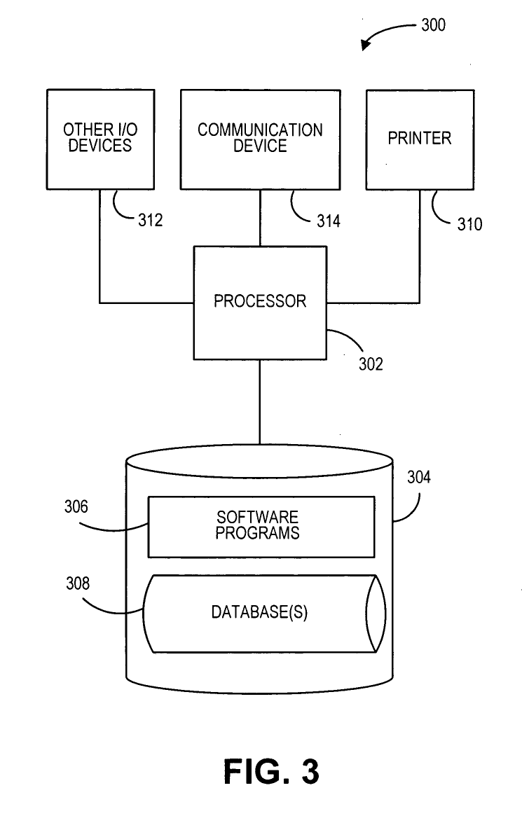

FIG. 3 is a simplified block diagram of an exemplary computer system 300 provided in accordance with aspects of an embodiment of the invention. The computer system 300 may be entirely conventional in its hardware aspects, but may include and be controlled by software to provide functionality as described hereinabove and below to implement aspects of the present invention. In particular the hardware of the computer system 300, and a portion of the software, may be such as is provided for a conventional personal computer or another type of computer that is operated to print checks.

The computer system 300 includes a processor 302, which in practice may be constituted by one or more conventional microprocessors. The computer system 300 also includes one or more memory/storage devices (represented by block 304) which are in communication with the processor 302. For example, the memory/storage device(s) 304 may include read only memory (ROM), random access memory (RAM), flash memory, one or more hard disk drives, drives for one or more removable disk-shaped storage media, etc., none of which is shown separately from block 304. The memory/storage device(s) may function as both program and working memory and may store various software programs 306 as described in more detail below. The software program includes program instructions which cause the processor 302 to operate so as to perform functions described herein.

The memory/storage device(s) 304 may also store one or more databases 308. The databases 308 may store data required to generate check printing data, and data that reflects checks that were previously printed.

Further, the computer system 300 includes a printer 310 which is in communication with the processor 302. The printer 310 may be a conventional printer of a type used to print checks and may also be employed to print documents other than checks. For example, the printer 310 may be a laser printer.

In addition, the computer system 300 may include other customary input/output devices, which may be in communication with the processor 302 and which are represented by block 312 in the drawing. For example, the other input/output devices may include a keyboard, a mouse, and a display device, none of which is separately shown in the drawing.

Still further, the computer system 300 includes a communication device 314 which is also in communication with the processor 302. The communication device 314 may be a network interface card, a modem and/or another device or devices that allow the computer system 300 to exchange data communications with external devices such as the computer (not explicitly shown) of the drawee bank.

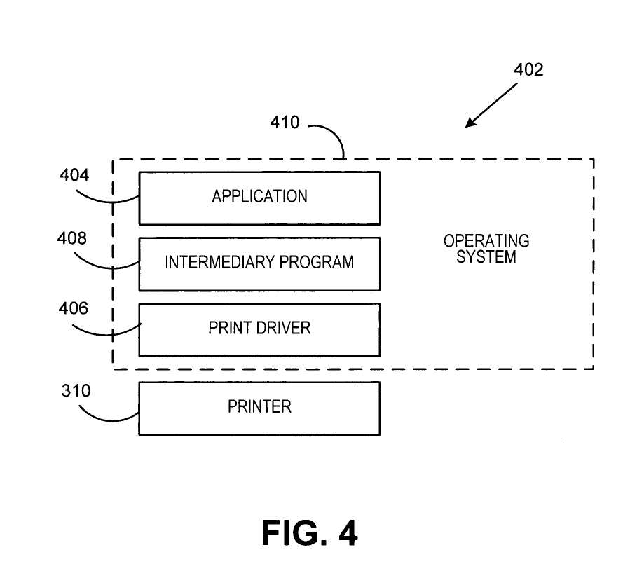

FIG. 4 is a schematic representation of software 402 provided in accordance with aspects of the invention to run on the computer system 300 (e.g., to control the processor 302). The software 402 illustrated in FIG. 4 may be considered to correspond to at least a portion of the software programs 306 represented in FIG. 3.

The software 402 includes the above mentioned application program (block 404) which may be a conventional accounting program or other application, operational to generate check printing data suitable for passing to a print driver. The software 402 also includes a conventional print driver 406.

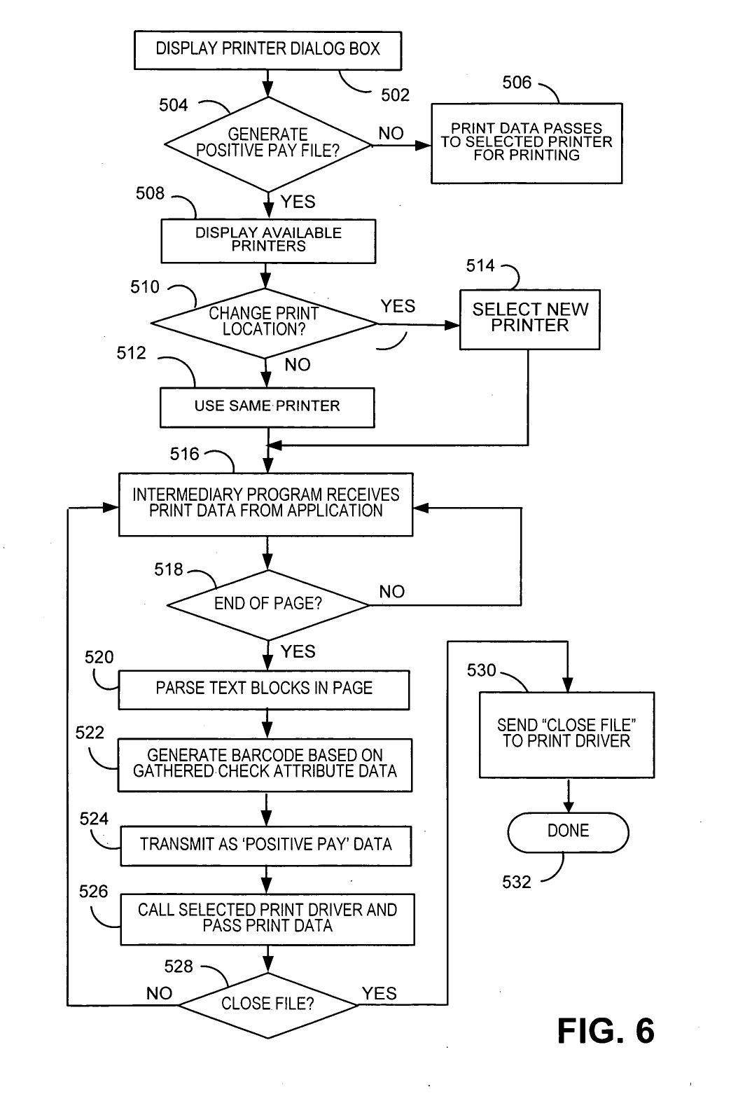

The software 402 further includes the above-mentioned intermediary program (block 408), provided in accordance with aspects of the invention and functionally inserted between the application 404 and the print driver 406 or adapted to monitor data being sent from the application 404 and print driver 406. Further details concerning the functions of the intermediary program 408 are provided below in conjunction with FIG. 6.

As indicated by dashed line block 410, the application 404, print driver 406 and intermediary program 408 may all run under a conventional operating system, such as an operating system from the family of “Windows” operating systems distributed by Microsoft Corporation. The print driver 406 drives the printer 310 in a conventional manner. Aspects of the printer 310 were described above in connection with FIG. 300.

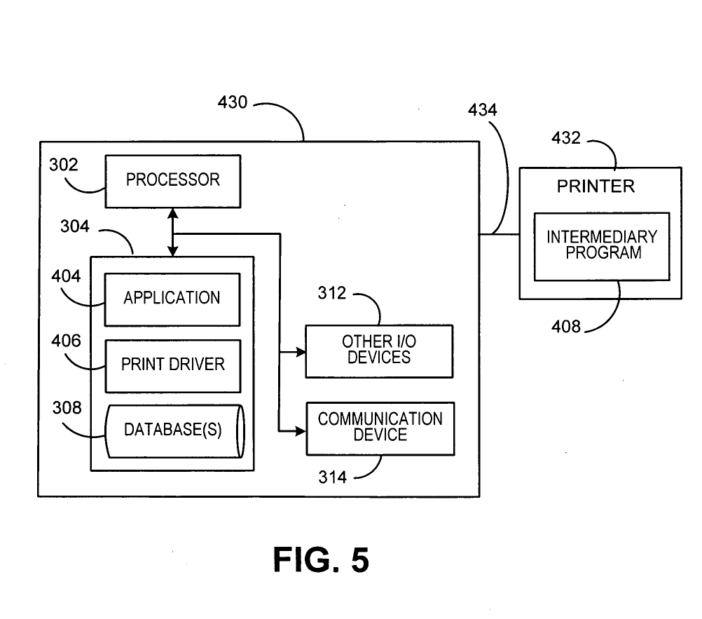

FIG. 5 is a simplified block diagram of an exemplary computer system 430 provided in accordance with aspects of another embodiment of the invention. In this embodiment, the printer 432 is a separate device, which may be a special purpose printer for printing checks, photos and the like, or may be a conventional general purpose printer, that is coupled to the computer system 430 via a communication channel 434, such as, for example a USB port. The intermediary program 408 resides in the printer 432 instead of in the computer system 430. The computer system 430 is similar to the computer system 300 described above with respect to FIGS. 3 and 4, with the exception noted above, and the description for like items (designated with the same reference numerals) need not be repeated. The intermediary program 408, located in the printer 432, will receive the check printing data that is being passed to the printer 432 from the computer system 430, and parse the data, as described further below, to generate check attribute data. The check attribute data can then be passed back to the computer system 430, via communication link 434, for transmission back to the drawee bank as described previously.

FIG. 6 is a flow chart that illustrates at least some of the functions performed by the application 404 and intermediary program 408 in some embodiments of the invention. At 502 in FIG. 6, upon the user invoking a print function of the application 404 after the application 404 has completed preparation of a check printing data for a check or a batch of checks, a printer dialog box (not shown) is displayed to a user of the computer system 300. This may be done, for example, by working through the operating system 410. The printer dialog box may be displayed on a display device that is part of the I/O devices 312 indicated in FIG. 3 (the display device is not otherwise shown). In accordance with conventional practices, the printer dialog box may allow the user to select among one or more selections of all printers installed on the computer system 300. The intermediary program 408, having been previously installed on the computer system 300, would be displayed in the printer dialog box along with other possible selections for printing devices. In step 504, it is determined if the user has selected to utilize the intermediary program 408 to obtain check attribute data for a positive pay file. If in step 504 the user has not selected to use the intermediary program 408, then in step 506 the check data is passed to the selected destination, e.g., a printer or the like, and the checks will be printed without any positive pay file being generated. If in step 504, it is determined that the user does wish to utilize the intermediary program 408 to generate a positive pay file, then in step 508 the intermediary program 408 will cause a second printer dialog box to be displayed to allow the user to select from available destinations, e.g., printers, in order to determine the particular printer to be used for printing the checks. (It may be assumed that the printer 310 shown in FIG. 3 may be one of a number of printers—not separately shown—which may be coupled to or included in the computer system 300. It may also be assumed that one or more of the printers are coupled to the computer system 300 by a data network, which also is not separately shown.)

At 510 it is determined, in response (e.g.) to the user's interaction with the second printer dialog box, whether the user has selected a new printer for printing of the batch of checks. If not, then the printer previously employed for the last batch of checks is selected to print the current batch of checks, as indicated at 512. However, alternatively, the user may have selected a new printer, as indicated at 514.

When selection of the printer has been accomplished, the intermediary program 408 commences to receive the check printing data from the application 404, as indicated at 516 in FIG. 6. Then, at 518, the intermediary program 408 may determine whether it has obtained a full page of check printing data from the application 404. Each page of check printing data may include check printing data for one or more checks. If not, the process loops back to 516, as the intermediary program 408 continues to receive check printing data from the application 404. However, if the intermediary program determines at 518 that it has obtained a full page of check printing data (e.g., in response to an end of page indication from the application 404), then the process of FIG. 5 advances to block 520.

At 520, the intermediary program 408 parses the page of check printing data to extract check attribute data from the check printing data. More particularly, the intermediary program may parse (e.g., read and/or detect the format of) blocks of text data included in the page of check printing data.

The purpose for parsing the page of check printing data is to gather check attribute data regarding the check to be printed using the page of check printing data. The check attribute data may be of the types referred to above, such as one or more of: check serial number, check amount (courtesy and/or legal amount), date of the check, name of payee, account number, routing number, or signature. Typically, for at least some types of check attribute data, the format of the text information in each text block in the page is adequate to allow the intermediary program to identify which type of desired check attribute data, if any, is contained in the text block. For example, a text block that contains a dollar sign (“$”) followed by one or more numerals, followed by a decimal point (“.”, which may also be identified as a period), followed by two more numerals, can be reliably detected as the (courtesy) dollar amount of the check, and the text data in that block may be interpreted accordingly to extract the (courtesy) dollar amount.

As another example, a text block that contains a string of letters, followed by a space, followed by one or two numerals, followed by a comma, followed by a space, followed by four numerals (of which the first two are “20”), can be reliably detected as the date of the check, and the check attribute corresponding to the date of the check may be extracted accordingly from the text block.

As still another example, a text block that contains only letters except for possibly also including one or more spaces or periods may be interpreted as the payee's name. A text block that contains only letters forming words representing numbers, e.g., one hundred thirty three, can be reliably detected as the legal amount of the check. To disambiguate between the possibilities for the check attribute data, the position of the text block in the check (and/or in the page of check printing data) may be taken into account. Position in the check or page of check printing data may be judged based in terms of either or both of: (a) absolute or relative coordinates at which the text is to be printed on the check blank, or (b) the order in which the text block appears in the page of check printing data relative to other check blocks. (Either or both of these may be considered to indicate the position of the text block in the check, or where in the check the text block is to be printed.) For example, if a text block having the format described in the first sentence of this paragraph is placed ahead of the courtesy dollar amount in the page of check data, then it may be concluded that the text block represents the name of the payee.

Similar conclusions may be drawn from the content and/or format of the information in other text blocks in the page of check data and/or from the position of the text blocks in the check or page of check data. (For present purposes, and for the appended claims, each text block may be considered to be a “data field”.)

Optionally, at 522, the intermediary program 408 can generate a barcode that includes at least a portion of the check attribute data gathered at 520. The barcode can be, for example, a machine readable 2-Dimensional barcode which can be read to provide additional authentication properties for each check. Thus, if the attributes of the check have been changed on the actual physical check, the attributes as recorded in the barcode will not match (unless the original barcode on the check has been replaced with a new barcode generated based on the altered check attributes). Preferably, the barcode is encrypted or signed with a digital signature, thereby providing additional security measures against the unauthorized generation of such barcodes.

At 524 in FIG. 6, the intermediary program 408 either transmits the check attribute data gathered at 520 as “positive pay” data to the drawee bank, or holds the check attribute data for later transmission (not separately indicated) to the bank. The transmission of the check attribute data to the bank may be substantially real-time, or may be on a batch basis. Before, during and/or after transmission of the positive pay data, the intermediary program 408 calls (step 526) the print driver which corresponds to the printer selected at 510-514. As part of the call to the print driver, the intermediary program 408 passes the page of check printing data to the print driver. Consequently, the selected printer is caused by the print driver to print a check that corresponds to the page of check printing data. If a barcode was generated at 522, the intermediary program 408 will pass the generated barcode along with the page of check printing data to the print driver, and the barcode will also be printed by the selected printer on the respective check.

Following steps 520-526, the intermediary program 408 determines at 528 whether a “close file” indication has been provided from the application 404. If not, the process loops back to 516, and the intermediary program 408 obtains the next page of check printing data from the application 404. However, if at 528 the intermediary program 408 determines that there has been a “close file” indication, then the process advances from 528 to 530. At 530, the intermediary program 408 passes the “close file” indication on to the print driver. The process then concludes (532).

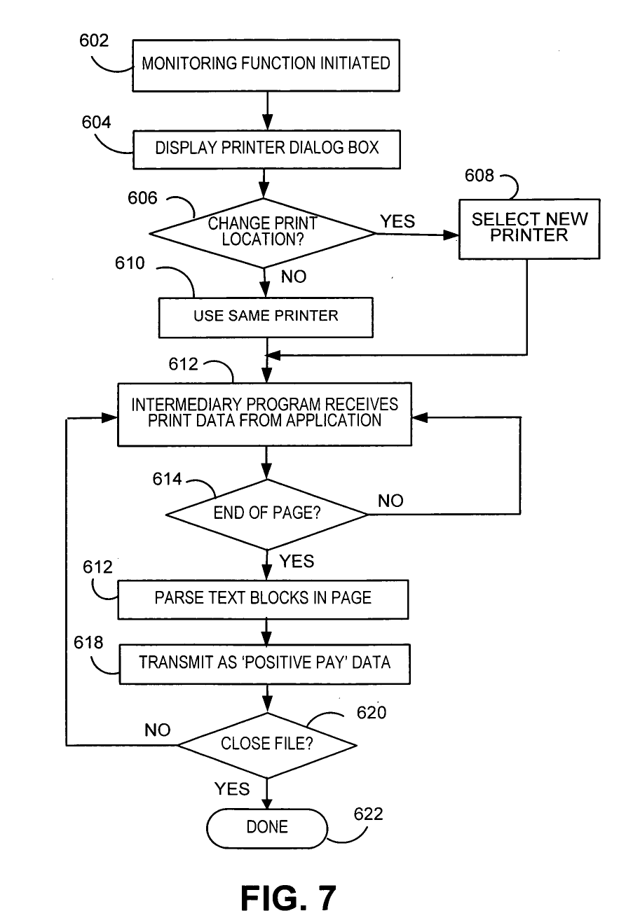

FIG. 7 is a flow chart that illustrates at least some of the functions performed by the application 404 and intermediary program 408 in some embodiments of the invention. In this embodiment, the intermediary program 408 monitors the check printing data as it is being passed from the application 404 to the selected printer that will print the checks. The intermediary program 408 may be located within the computer system 300 (as illustrated in FIGS. 3 and 4, or alternatively may be provided directly in the printer 432 as illustrated in FIG. 5). At 602 in FIG. 7, the monitoring function of the intermediary program 408 is activated. This can be performed automatically upon start up of the computer system 300 (or printer 432), or alternatively in response to user selection to activate the intermediary program 408. At 604, upon the user invoking a print function of the application 404 after the application 404 has completed preparation of a check printing data for a check or a batch of checks, a printer dialog box (not shown) is displayed to the user of the computer system 300 similarly as described previously with respect to FIG. 6. In step 606, it is determined, in response (e.g.) to the user's interaction with the printer dialog box whether the user has selected a new printer for printing of the checks. If not, then the printer previously employed for the last batch of checks is selected to print the current batch of checks, as indicated at 608. However, alternatively, the user may have selected a new printer, as indicated at 610.

When selection of the printer has been accomplished, the intermediary program 408 commences to receive the check printing data from the application 404, as indicated at 612 in FIG. 7 by monitoring the check printing data being sent to the selected printer. At 614, the intermediary program 408 may determine whether it has obtained a full page of check printing data from the application 404. If not, the process loops back to 612, as the intermediary program 408 continues to receive check printing data from the application 404. However, if the intermediary program determines at 614 that it has obtained a full page of check printing data (e.g., in response to an end of page indication from the application 404), then the process of FIG. 7 advances to block 616, where the intermediary program 408 parses the page of check printing data to extract check attribute data from the check printing data similarly as described above with respect to FIG. 6. At 618 in FIG. 7, the intermediary program 408 either transmits the check attribute data gathered at 616 as “positive pay” data to the drawee bank, or holds the check attribute data for later transmission (not separately indicated) to the bank. The transmission of the check attribute data to the bank may be substantially real-time, or may be on a batch basis. If the intermediate program 408 is located in the printer 432 as illustrated in FIG. 5, the transmission of the check attribute data gathered as 616 is done through the computer system 432, via connection 434, to the drawee bank.

At 620, the intermediary program 408 determines whether the check printing data being sent from the application program 404 has ended. If not, the process loops back to 612, and the intermediary program 408 obtains the next page of check printing data from the application 404. However, if at 620 the intermediary program 408 determines that there is no more data being sent, the process then concludes (622).

In some embodiments, the check attribute data gathered at 520 and 616 may be stored in the form of an XML file. Thereafter, (e.g., in batch, and/or after close of file), a utility program (not separately indicated), or the intermediary program itself, may apply an XSLT transformation to the XML file to translate the check attribute data into a format prescribed by the drawee bank. If a utility program is employed for this purpose, it may be possible to use a standard version of the intermediary file in all installations.

The above description, and the flow charts herein, are not meant to imply a fixed order of the enumerated process steps. Rather, the process steps may be performed in any order that is practicable.

A number of embodiments of the present invention have been described. Nevertheless, it will be understood that various modifications may be made without departing from the spirit and scope of the invention. Other variations relating to implementation of the functions described herein can also be implemented. Accordingly, other embodiments are within the scope of the following claims.

What is claimed is:

1. A method comprising:
receiving print data from an application program, the print data suitable for causing a print driver to cause a printer to print a check;
parsing the print data to identify data fields in the print data, the data fields indicative of attributes of the check;
storing data from the identified data fields, said stored data being check attribute data; and
transmitting the stored check attribute data to a bank upon which the check is drawn.

2. The method according to claim 1, wherein said parsing includes detecting, for at least some blocks of text within the file of print data, what check attributes the blocks of text correspond to.

3. The method according to claim 2, wherein said detecting includes reading contents of said blocks of text.

4. The method according to claim 3, wherein said detecting includes determining at what position in said check one of said blocks of text is to be printed.

5. The method according to claim 1, wherein the stored check attribute data includes a dollar amount of the check and a serial number of the check.

6. The method according to claim 5, wherein the stored check attribute data also includes at least one of a date of the check, name of payee of the check, an account number corresponding to an account on which the check is drawn, a check routing number, and a signature on the check.

7. The method according to claim 1, wherein the stored check attribute data is in the form of an XML (Extensible Markup Language) file and the transmitting step includes:
translating the XML file with an XSLT (Extensible Stylesheet Language Transformations) transformation to produce an output file, the output file in a format prescribed by the bank; and
transmitting the output file to the bank.

8. The method according to claim 1, further comprising:
passing the print data to a print driver.

9. The method according to claim 8, wherein passing the print data to the print driver further comprises:
allowing a user to select a printer from among a plurality of printers;
receiving an indication from the user as to selection of the printer;
based at least in part on the indication from the user as to selection of the printer, selecting the print driver from among a plurality of print drivers;
passing the print data to the selected print driver; and
printing the check.

10. The method according to claim 8, further comprising:
generating a barcode based on the check attribute data; and
passing the generated barcode to the print driver.

11. The method according to claim 10, further comprising:
providing a digital signature for the barcode.

12. The method according to claim 1, wherein application program is an accounting program.

13. A method of protecting against check fraud, the method comprising:
generating check printing data using an accounting application program for one or more checks, said check printing data including a plurality of text blocks for each of said one or more checks;
invoking a print function of said accounting application program with respect to said check printing data;
receiving said check printing data at an intermediary program,
parsing said check printing data using said intermediary program, said parsing including reading at least some of the text blocks in said each check to detect a type of data included in each of said at least some of the text blocks, said detecting including determining with respect to at least some of said text blocks where in each check said text blocks are to be printed;
extracting data from said text blocks and storing said extracted data as check attribute data which corresponds to said detected types of data;
passing the check printing data to a print driver to drive a printer to print checks corresponding to the check printing data;
translating said check attribute data to a format prescribed by a bank on which the checks are drawn; and
transmitting the translated check attribute data to the bank on which the checks are drawn.

14. The method according to claim 13, wherein the stored check attribute data includes dollar amounts of the checks, and serial numbers of the checks.

15. The method according to claim 14, wherein the stored check attribute data also includes at least one of a date of the checks, names of payees of the checks, an account number corresponding to an account on which the checks are drawn, a check routing number, and a signature on the checks.

16. The method according to claim 13, wherein prior to said translating, said check attribute data is in the form of an XML (Extensible Markup Language) file, and said translating includes applying an XSLT (Extensible Stylesheet Language Transformations) transformation to said XML file.

17. The method according to claim 13, further comprising:
allowing a user to select the printer from among a plurality of printers;
receiving an indication from the user as to selection of the printer; and
based at least in part on the indication from the user, selecting a print driver from among a plurality of print driver to drive the selected printer.

18. The method according to claim 13, further comprising:
scanning the checks at the bank on which the checks are drawn to extract check attribute data from the scanned checks; and
comparing the check attribute data extracted from the scanned checks with the check attribute data transmitted to the bank.

19. The method according to claim 13, further comprising:
generating a barcode, using the intermediary program, based on the check attribute data;
passing the generated barcode from the intermediary program to the print driver program to drive the printer to print a respective generated barcode on each check.

20. An apparatus comprising:
a processor; and
a memory in communication with the processor and storing program instructions, the processor operative with the program instructions to:
parse print data generated by an application program to identify data fields in the print data, the print data suitable for passing to a print driver to cause a printer to print a check, the data fields indicative of attributes of the check;
store data from the identified data fields, said stored data being check attribute data; and
transmit the stored check attribute data to a bank upon which the check is drawn.

21. The apparatus according to claim 20, wherein said parsing includes detecting, for at least some blocks of text within the print data, what check attributes the blocks of text correspond to.

22. The apparatus according to claim 21, wherein said detecting includes reading contents of said blocks of text.

23. The apparatus according to claim 22, wherein said detecting includes determining at what position in said check one of said blocks of text is to be printed.

24. The apparatus according to claim 20, wherein the stored check attribute data includes a dollar amounts of the check, and a serial number of the check.
